(19) United States
(12) Patent Application Publication
(10) Pub. No.: US 2026/0370670 A1
(43) Pub. Date: Nov. 19, 2026

(54) METHOD AND SYSTEM FOR NAMING PROCESS PARAMETERS IN INDUSTRIAL NETWORKS

(71) Applicant: Honeywell International Inc., Charlotte, NC (US)

(72) Inventors: Alexey Khitrov, Tel Aviv (IL); Adam Engelhart, Bruchin (IL)

(21) Appl. No.: 19/208,629

(22) Filed: May 15, 2025

(51) Int. Cl. H04L 9/40; G05B 19/418

(52) U.S. Cl. CPC H04L 63/1425; G05B 19/41845; G05B 19/4185

(57) ABSTRACT

The present disclosure provides a method for naming process parameters in industrial networks. The method comprises monitoring a plurality of data packets transmitted through one or more network levels of an industrial network. The method further comprises determining a communication protocol for each data packet of the plurality of data packets, wherein the communication protocol for each data packet varies based on the one or more network levels. The method further comprises inspecting payload of each data packet to identify a process parameter and its associated process parameter value, wherein the process parameter value is generated by a process control device. The method further comprises creating a tag name for the process parameter in each data packet in a standard nomenclature across the one or more network levels, wherein the standard nomenclature is created by mapping metadata of each data packet to a corresponding user-defined tag name for the process parameter. The method further comprises presenting data comprising the process parameter and its associated process parameter value, and the user defined tag name for each data packet to a user. The method further comprises performing one or more operations on the data. A system for naming process parameters in industrial networks is also disclosed.

### TECHNICAL FIELD

Embodiments of the present disclosure generally relate to process control environments. Particularly, the present disclosure relates to a method and system for naming process parameters in process control environments.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Enterprises engaged in industrial activities typically rely on Operational Technology (OT) systems to automate and improve the efficiency of their operations. Such OT systems find applications in various sectors such as manufacturing, energy, mining, oil and gas, power generation, refining, water treatment and distribution, waste water collection and treatment, electrical power transmission and distribution, heating, ventilation and air conditioning systems (HVAC), chemical plants to name a few. Industrial Control System (ICS) is a segment of OT systems which monitor and control industrial assets typically installed at remote locations. ICS is often managed by Supervisory Control and Data Acquisition Systems (SCADA) which provides a graphical user interface or a human machine interface (HMI) for operators to observe the status and performance of the remote assets so as to control and adjust their operations in real-time.

As OT assets are part of complex interconnected systems, they are generally vulnerable to cyber security threats. Cyber security threats may result from malicious attacks on data that is transmitted through the network. The data may be a characteristic of the process or a physical system that is controlled in the industrial network. The data may comprise process variables or parameters like temperature, pressure, level, flow rate, etc. of assets which are measured and controlled by process control devices. The transmission of data between components such as the sensors, PLCs, SCADA is carried out using such process variables or process parameters over various communication protocols. The process parameters indicate the physical state or behavior of the system, and the value of the process parameter is the current state or data of the process parameters. Therefore, any manipulation or alteration to process parameter values by network intruders can alter the behavior of the OT system causing operational disruptions. For example, cyber security threats can lead to operational instability including shut down of operations of the assets, physical damage to the assets and in certain instances can result in life-threatening situations.

Therefore, addressing security breaches or network intrusions by unauthorized parties in OT networks is paramount. If security threats are timely addressed, it would help prevent downtime of physical assets and damage to critical infrastructure. It would also help avoid increased operational costs and safety risks. Thus, quickly identifying, prioritizing and responding to threats and vulnerabilities is essential so that the overall productivity of the industrial processes is not impacted due to malicious actors. Early and quick detection of security risks also helps industrial organizations to gain better visibility into their OT cyber security posture.

Accordingly, there is a need to ensure security in OT space by preventing malicious attacks so that the industrial operations remain secure and stable, thereby improving the overall health of the system. Thereby, enterprises can achieve an efficient framework for securing process control environments, which enables early attack detection and better management of cyber risks.

The present disclosure aims to provide an efficient mechanism for naming the process parameters that are transmitted through the OT network by utilizing an Intrusion Detection System (IDS) or cyber insights (CI) system. The IDS enables the security teams to passively and continuously monitor the process parameters generated by process control devices in real-time and provide a standard naming convention to the process parameters, so as to quickly detect security vulnerabilities and thereby achieve improved visibility on threats and cyber insights for business intelligence purposes.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure relate to better managing cybersecurity risks in industrial networks by utilizing an intrusion detection system to passively monitor the data packets transmitted through the network. Other implementations will be, or will become, apparent to one with skill in the art upon examination of the following figures and detailed description. It is intended that all such additional implementations be included within this description be within the scope of the disclosure and be protected within the scope of the following claims.

The present disclosure provides techniques for securing OT traffic by using an intrusion detection system (IDS), which passively monitors data packets transmitted across different network levels or network layers in the industrial network. Specifically, the present disclosure provides a method and system for naming process parameters transmitted through OT networks. The IDS has the ability to identify the process parameters and render a standard nomenclature to the process parameters in order for the security teams to quickly decipher the type of process parameter being transmitted across the network levels. To this end, the present disclosure provides a mechanism of mapping the metadata of each data packet transmitted through the network to a corresponding user-defined tag name of the process parameter. Assigning user-defined names to process parameters significantly reduces time and effort required to detect security vulnerabilities.

In one embodiment, the present disclosure provides a method for naming process parameters in industrial networks. The method comprises monitoring a plurality of data packets transmitted through one or more network levels of an industrial network. The method further comprises determining a communication protocol for each data packet of the plurality of data packets, wherein the communication protocol for each data packet varies based on the one or more network levels. The method further comprises inspecting payload of each data packet to identify a process parameter and its associated process parameter value, wherein the process parameter value is generated by a process control device. The method further comprises creating a tag name for the process parameter in each data packet in a standard nomenclature across the one or more network levels, wherein the standard nomenclature is created by mapping metadata of each data packet to a corresponding user-defined tag name for the process parameter. The method further comprises presenting data comprising the process parameter and its associated process parameter value, and the user defined tag name for each data packet to a user. The method further comprises performing one or more operations on the data.

In an embodiment, the method further comprises saving the standard nomenclature in a configuration file.

In an embodiment, the method further comprises storing the data comprising the process parameter and its associated process parameter value, and the user-defined tag name for each data packet.

In an embodiment, the metadata for each data packet varies based on the communication protocol. In an embodiment, the metadata comprises memory address from where the process parameter value is fetched. In another embodiment, the metadata comprises an identifier of the process parameter.

In an embodiment, the process control device controls an industrial process. In an embodiment, the process parameter comprises a characteristic of the industrial process controlled by the process control device.

In an embodiment, the data presented to the user is utilized for detecting security threats within the industrial network. In another embodiment, the data presented to the user is utilized for business intelligence.

In an embodiment, the present disclosure provides a system for naming process parameters in industrial networks. The system comprises a processor and a memory storing program instructions which, when executed by the processor, causes the processor to monitor a plurality of data packets transmitted through one or more network levels of an industrial network. The processor is further configured to determine a communication protocol for each data packet of the plurality of data packets, wherein the communication protocol for each data packet varies based on the one or more network levels. The processor is further configured to inspect payload of each data packet to identify a process parameter and its associated process parameter value, wherein the process parameter value is generated by a process control device. The processor is further configured to create a tag name for the process parameter in each data packet in a standard nomenclature across the one or more network levels, wherein the standard nomenclature is created by mapping metadata of each data packet to a corresponding user-defined tag name for the process parameter. The processor is further configured to present data comprising the process parameter and its associated process parameter value, and the user defined tag name for each data packet to a user. The processor is further configured to perform one or more operations on the data.

In an embodiment, the processor is configured to save the standard nomenclature in a configuration file.

In an embodiment, the processor is configured to store the data comprising the process parameter and its associated process parameter value, and the user-defined tag name for each data packet.

In an embodiment, the present disclosure provides a non-transitory computer-readable storage medium, storing program instructions executed by a processor for naming process parameters in industrial networks. The program instructions when executed by the processor, monitors a plurality of data packets transmitted through one or more network levels of an industrial network. The program instructions when executed by the processor, determines a communication protocol for each data packet of the plurality of data packets, wherein the communication protocol for each data packet varies based on the one or more network levels. The program instructions when executed by the processor, inspects payload of each data packet to identify a process parameter and its associated process parameter value, wherein the process parameter value is generated by a process control device. The program instructions when executed by the processor, creates a tag name for the process parameter in each data packet in a standard nomenclature across the one or more network levels, wherein the standard nomenclature is created by mapping metadata of each data packet to a corresponding user-defined tag name for the process parameter. The program instructions when executed by the processor, presents data comprising the process parameter and its associated process parameter value, and the user defined tag name for each data packet to a user. The program instructions when executed by the processor, performs one or more operations on the data.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary general block diagram of an environment in which the embodiments of the present disclosure may be implemented;

FIG. 2 illustrates a prior art process control environment illustrating various network levels at which operations are performed;

FIG. 3 illustrates an exemplary block diagram of a system for naming process parameters in industrial networks, in accordance with one or more embodiments described herein;

FIG. 4 illustrates an exemplary scenario of data flow in a process control environment with network intrusion;

FIG. 5 illustrates another exemplary scenario of data flow in a process control environment with network intrusion;

FIG. 6 is an exemplary illustration of a data flow of a process control environment monitored by the system (of FIG. 3) in accordance with one or more embodiments described herein;

FIG. 7 is an exemplary mapping schema implemented by the system of FIG. 3 for naming process parameters in accordance with the one or more embodiments described herein;

FIG. 8 is an exemplary table showing the creation of tag names by the system of

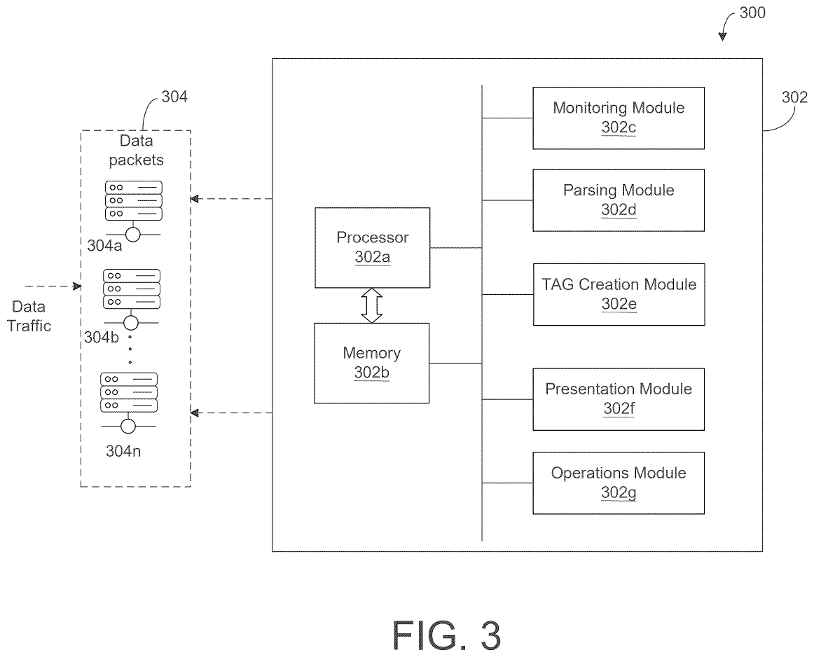

FIG. 3 in accordance with the one or more embodiments described herein;

FIG. 9 is an exemplary table showing insights on the OT traffic monitored by the system of FIG. 3 in accordance with the one or more embodiments described herein;

FIG. 10 is a flow diagram of a method for naming process parameters in industrial networks, in accordance with one or more embodiments described herein; and

FIG. 11 illustrates a general block diagram of a computing system that may be used by the method and system, in accordance with one or more embodiments described herein.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Those skilled in the art will understand that the principles of the disclosure may be implemented in any type of suitably arranged device or system. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Business enterprises engaged in industrial activities typically rely on Operational Technology (OT) systems to automate and improve the efficiency of their operations. Such OT systems find applications in various sectors such as manufacturing, energy, mining, oil and gas, power generation, refining, water treatment and distribution, waste water collection and treatment, electrical power transmission and distribution, heating, ventilation and air conditioning systems (HVAC), chemical plants to name a few. Industrial Control System (ICS) is a segment of OT systems which monitor and control industrial assets typically installed at remote locations.

Typically, security teams in OT systems monitor the network traffic in real-time to detect potential threats, security breaches or intrusions and vulnerabilities in the data that is transmitted through the OT traffic. The data may be a characteristic of the process or a physical system that is controlled in the industrial network. The data may comprise process variables or parameters like temperature, pressure, level, flow ate, etc. of assets which are measured and controlled by process control devices. The process parameters may indicate the physical state or behavior of the system, and the value of the process parameter is the current state or data of the process parameters.

Examples of process control devices may collectively include field devices and programmable logic controllers (PLC). Examples of field devices may include measuring and control devices such as sensors, actuators, valves, etc. to measure and control the process parameters. The PLC may monitor such process parameters to control and maintain their values at a desired target value. Any manipulation or alteration to process parameter values by network intruders can hamper the operations of the assets. For instance, the operation of the asset may be tampered as a result of writing a new program on PLC or updating the configuration of the PLC.

Therefore, the OT space harbor vulnerabilities as a result of network intrusion that pose significant security risks. Security teams typically invest a lot of time, resources and efforts to detect and remediate such cybersecurity threats. This leads to delays in addressing critical vulnerabilities and thereby escalating the risk of security breaches. Also, the absence of an efficient solution for managing the security threats results in operational inefficiencies and increased exposure to potential exploits. This deficiency becomes problematic for large industrial organizations managing activities at various remote locations, as it necessitates substantial manual effort to maintain a secure environment.

Therefore, malicious attacks in the network traffic have to be addressed quickly to secure OT traffic. Also, continuous monitoring and protection of OT environment is essential so that customer relationships and overall productivity are not impacted. Also, providing a standard naming convention for process parameters help in quickly addressing security vulnerabilities, significantly reducing the risk of breaches. Adapting a standard nomenclature for the process parameters enables seamless data flow and also aids the security teams to work independently of the development and operations teams, significantly reducing the costs. Organizations can also save time and resources and ensure timely remediation of vulnerabilities. Consistent availability of data and information on the performance of assets can reduce the likelihood of security breaches. Also, gaining cyber insights on the OT system enhances overall security posture and aids business intelligence.

Accordingly, there is a need to provide an efficient system for providing improved reliability and accuracy of data, quick resolution of security issues, reduced operational costs and risks, continuous protection and stability of industrial operations, thereby facilitating overall cybersecurity posture.

There is also a need to provide an efficient system and framework for providing better visibility into the security risks of OT environments and gaining insights on enhanced protection of assets.

To this end, the present disclosure provides a method for identifying the process parameters and their associated process parameter values transmitted through an industrial network. Specifically, the disclosure aims to provide a standard nomenclature for process parameters so that they are quickly decipherable by the security teams while monitoring network traffic. The approach gives the security teams the unique ability to identify process parameters in the monitored traffic without the assistance of the operational teams (operators/engineers). Assigning user-given names to process parameters allows bridging the communication gaps between the security teams and the operators of the industrial process. It helps industrial organizations to improve the security of their OT environment and to improve their ability to avoid disruptions in operations and ensure safety.

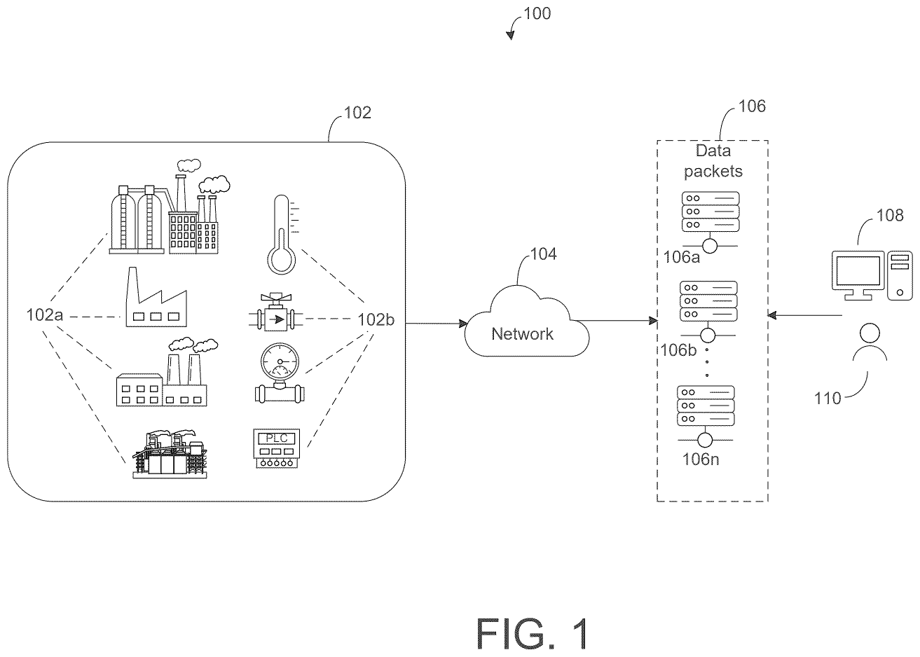

FIG. 1 illustrates an exemplary block diagram of an environment 100 in which the embodiments of the present disclosure may be implemented. Enterprises engaged in industrial activities typically rely on Operational Technology (OT) systems to automate and improve the efficiency of their operations. Such OT systems find applications in various sectors including but not limited to manufacturing, energy, mining, oil and gas, power generation, refining, water treatment and distribution, waste water collection and treatment, electrical power transmission and distribution, heating, ventilation and air conditioning systems (HVAC), chemical plants. Industrial Control System (ICS) is a segment of OT systems which monitor and control industrial assets typically installed at remote locations. FIG. 1 illustrates such an exemplary OT system 102 operating an industrial process or physical process. The OT system 102 typically monitors and manages an organization's industrial operations.

As seen in FIG. 1, the OT system 102 includes an industrial setting such as a manufacturing or chemical plant 102a and, the machinery needed to control the industrial operations, physical equipment or assets. In an embodiment, the machinery may include process control devices 102b. Examples of process control devices 102b may collectively include field devices and programmable logic controllers (PLC). Examples of field devices may include measuring and control devices such as sensors, actuators, valves, 102b to measure and control parameters of the physical process. These parameters may be called the process parameters or process variables. The process parameters may be data representing a characteristic of the physical process being controlled by the OT system 102. The data may include parameters like temperature, pressure, level, flow rate, etc. which are measured and controlled by process control devices 102b. The process parameters indicate the physical state or behavior of the system, and the value of the process parameter is the current state or data of the process parameters. The process parameters may have certain desired target values or setpoints to keep the industrial assets under appropriate working conditions. The PLC may monitor such process parameters to control and maintain the process parameter values at the desired target value or setpoint.

Other equipment and process control devices may also part of the plant 102a and the system described herein is not limited to the equipment specifically illustrated in FIG. 1 but may include any other types of process control equipment or devices.

In an embodiment, the data may be transmitted by the OT system 102 over a communication network or a data gateway 104. According to various embodiments, the network 104 may be configured to provide communication between various components depicted in FIG. 1. In some embodiments, the network 104 may include a public network (e.g., the Internet), (e.g., an internal localized, or closed-off network between particular devices). In some other embodiments, the network 104 may be a hybrid network (e.g., a network enabling internal communications between particular connected devices and external communications with other devices). Such configuration(s) include, without limitation, a wired or wireless Personal Area Network (PAN), a Cloud network, Local Area Network (LAN), Metropolitan Area Network (MAN), Wide Area Network (WAN), and/or the like. In various embodiments, the network 106 may include one or more relay(s), router(s), switch(es), routing station(s), and/or the like. The communication network 104 may utilize network components to establish connection among the various elements of the environment 100. The network components may include, hubs, switches, routers, bridges, and repeaters. The routers may be of different types such as Provide Edge (PE) routers, Customer Edge (CE) routers, and intermediate routers.

In an embodiment, the process parameters generated by the process control devices such as sensors and actuators are embodied in data packets 106 transmitted through the network 104. FIG. 1 illustrates a plurality of such data packets 106a-106n. Each data packet 106a-106n may contain metadata such as a source address, destination address, payload data or content, an identifier of the type of communication or network protocol being used for communication, error correction code, etc. The metadata of the data packet may vary based on the type of communication protocol. The data packets 106a-106n that are transmitted through the network may embody data that provide insights on the performance or working condition of the assets that is managed and controlled within the OT system 102. The data in an OT network typically includes values from field devices that indicate the physical state or behavior of the system.

In an embodiment, FIG. 1 shows a monitoring system 108 operable by one or more users 110. In an embodiment, the monitoring system 108 may be an intrusion detection system (IDS) or a cyber insights (CI) system for monitoring any cyber security risk in real-time in the network. The one or more users of the IDS 108 may be part of the security teams of the enterprises who monitor the data traffic in the network for any suspicious or malicious activity. Cybersecurity risk in an ICS may include any unauthorized access, any command or logic that is misconfigured or is vulnerable to attacks. The IDS 108 may passively monitor the network by mirroring the data traffic via the network 104 and without integrating with the networks within the enterprise. The mirroring approach of the system 108 ensures that ongoing operations within the enterprises remain unaffected.

The CI system, 108 of FIG. 1 and its components are explained in greater detail in FIG. 3.

In some embodiments, the components of the environment 100 may include any suitable combination of hardware, firmware and software. For example, the components of the environment 100 may use one or more elements of the computer system of FIG. 11. It is to be appreciated that the particular arrangements of system 100 as illustrated in FIG. 1 are presented by way of illustrative example only, and numerous other arrangements are possible.

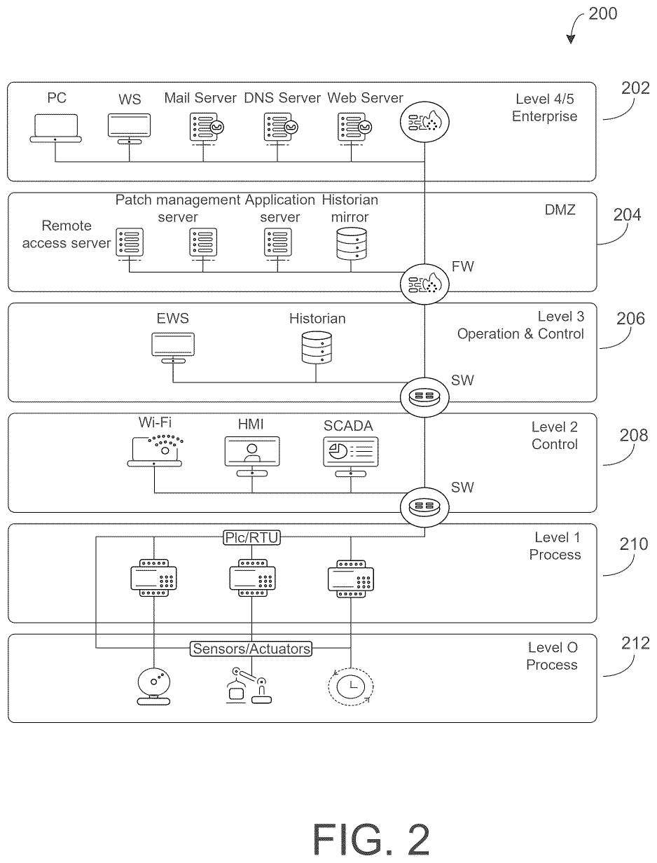

FIG. 2 illustrates a prior art process control environment illustrating various network levels at which operations are performed. Specifically, FIG. 2 illustrates a general architecture of an ICS network having separate layers or levels of the network to maintain a hierarchical flow of data between the network levels. The architecture separates the OT systems and enterprise IT systems to ensure security and data flow. The various network levels, L5 (212), L4 (210), L3 (208), L2 (206), L1(204), L0(202) as shown in FIG. 2 define the flow of data from physical devices in the OT system to the enterprise applications in the IT system.

The network Level L0, 212 is a device layer where various physical components and machineries exist. It includes sensors (measuring temperature, pressure, etc.) and actuators (valves, motors) that interact with the physical processes. The components and machineries located at this network level communicate with the components at the next network level through a dedicated channel using simple input output signals and hence there is an absence of internet networks at this network level.

The next network level L1, 210 includes components such as the PLCs, DCS, remote terminal units, RTUs which send commands or logic to the devices at level L0, 212. The PLCs communicate with the field devices such as the sensors and actuators in L0 to collect data and to control the physical process of the industrial enterprise. The field devices which may be for example, temperature sensors, pressure sensors, level and flow rate sensors, valves, valve positioners, actuators, among others, perform functions such as opening or closing of valves, measuring process parameters such as temperature and pressure to control the physical processes executing within the plant. The field devices send the measured values to PLCs which makes process control decisions and generate control signals to coordinate with the field devices. The control signals from the PLCs are sent to the field devices over the network to control at least one operation of the asset located within the plant.

At network Level L2, 208 of the ICS architecture are the components primarily for supervising, monitoring and controlling the physical process of the industrial enterprise. Level L2 comprises of the SCADA system that supervises and controls physical processes locally or remotely and sends data to historians at L3, 206. L2, 208 also contains the HMI for control and monitoring of the SCADA system. In an embodiment, the field devices and PLCs may be generally referred to as process control devices. The data and information from these process control devices is transmitted through the network or data gateway to be made available to the operators, engineers and security teams. The operations and security teams use the data and information to control the operations of the assets and to maintain cyber security within the network.

Network Level L3, 206 is the layer where Manufacturing Execution Systems (MES) and Production Management Systems function. These systems oversee workflows, production scheduling, quality assurance, and the allocation of resources within the plant. For example, MES collect real-time data during production process and historians store process data for data analytics purposes. The network level associated with these systems connects OT systems with IT infrastructure, using standard Ethernet and TCP/IP protocols. At level L3, data reliability and accuracy are prioritized as historical data storage and analysis are performed at this level.

Network Level 3.5, 204 is a network layer that serves as a buffer between the OT and IT networks. It enables secure data exchange between OT and IT systems, while protecting critical operational systems from potential security threats originating from the enterprise network.

Network Level 4/5, 202 of the architecture typically includes the enterprise IT network where the manufacturing operations are orchestrated. The Enterprise Resource Planning (ERP) Systems at this network level handle business logic, forecasting, procurement, and other production activities. Level L5, 202 includes cloud-based analytics, predictive maintenance systems, and Internet of Things (IoT) platforms that is capable of analyzing data across multiple plants or sites. The communication from level L4 to L5 is through Wireless Wide Area Network (WWAN) and is primarily used for analytics and business insights.

FIG. 3 illustrates an exemplary block diagram of a system 300 for naming process parameters in industrial networks, in accordance with one or more embodiments described herein. In an embodiment, the system 300 may be an Intrusion detection system (IDS) or a cyber insights (CI) system for monitoring and quickly detecting and remediating any cybersecurity risks in the OT network 104 (of FIG. 1) by giving a standard nomenclature to the process parameters transmitted through the network. The system 300 may comprise one or more components such as a monitoring module 302c, a parsing module 302d, a tag creation module 302e, a presentation module 302f and an operations module 302g for implementing the functions of the system 300.

In an embodiment, the system 300 comprises a monitoring module 302c configured to monitor the plurality of data packets 304 transmitted through one or more network levels 212-202 (of FIG. 2) of the ICS network. The plurality of data packets 304a-304n are transmitted across network levels, the data packets comprising data that contain measured parameters indicative of the operational condition or working condition of the physical assets at network level, L0, 202. The measured process parameters indicate the physical state or behavior of the system, and the value of the process parameter is the current state or data of the process parameters. In an example operation, a flow rate sensor may send measurement value regarding flow rate of an asset from L 0, 212 to a PLC at network L1, 210. The PLC may in turn send command or logic to the field devices such as an actuator or valves at Level L0, 212 to adjust the flow rate to a desired setpoint. The process parameter value is then transmitted to Level L2, 208 which comprises the SCADA system and the HMI for controls and monitoring by the operations teams and engineering teams. The measured process parameter values may be transmitted from one network level to another network level using proprietary communication protocols. In an embodiment, the monitoring module 302c is configured to passively monitor the network by inspecting a mirror of all the traffic sent to it by switches of the network. The monitoring module 302c may be able to understand the behavior of the industrial process it monitors.

In an embodiment, the system 300 further comprises a parsing module 302d coupled to the monitoring module 302c. The parsing module 302d is configured to determine a communication protocol for each data packet of the plurality of data packets 304a-304n, wherein the communication protocol for each data packet varies based on the one or more network levels. The data packet is parsed and processed based on the metadata of the data packet. The metadata may include source address, destination address, an identifier of the type of communication protocol, payload, etc. For example, the communication protocol utilized for transmission of data packets at L0, 212 may be different from the communication protocol utilized at L1, 210. Similarly, the communication protocol for transmission of data packets at L1 may be different from L2. In an embodiment, the parsing module 302d utilizes Deep Packet Inspection (DPI) capabilities to understand various proprietary communication protocols used by manufacturers of industrial assets and SCADA systems. Few examples of industrial communication protocols used at different network levels may include Modbus TCP, PROFINET, Ethernet/IP, OPC UA, TCP/IP, HTTP, etc. In an example embodiment, while network level L1 may employ proprietary OT and Fieldbus/Ethernet RT protocols for communication, network level L2 may employ SCADA proprietary protocols to facilitate communication between SCADA and PLC.

In an embodiment, the parsing module 302d is further configured to inspect payload of each data packet to identify a process parameter and its associated process parameter value, wherein the process parameter value is generated by a process control device. In an example embodiment, process control devices such as the temperature sensors, pressure sensors, level and flow rate sensors, etc. may measure values of the process parameters which represent the current state of the process parameters. Large number of such process parameter values are transmitted across various network levels of the enterprise indicating the physical state of the industrial process being monitored. In an embodiment, the DPI technology enables the parsing module 302d to parse the payload content based on the determined communication protocol. The parsing module 302d is further configured to detect commands used for exchange of process parameters, discern between the values of process parameters and attribute them to process parameters.

In an embodiment, the system 300 further comprises a tag creation module 302e coupled to the parsing module 302d. The tag creation module 302e is configured to create a tag name for the process parameter embodied in each data packet. In an embodiment, the tag creation module 302e is configured to create the tag names in a standard nomenclature across the one or more network levels. The standard nomenclature for the tag names is created by mapping metadata of each data packet to a corresponding user-defined tag name for the process parameter. Typically, the metadata of a data packet may include identifiers or tags for process parameters or in some examples, the metadata may include memory address from where the process parameter values are read. The metadata for each data packet may vary based on the communication protocol being used across various network levels.

In one implementation, when a data packet is transmitted, the metadata of the packet may include a technical identifier for the process parameter and the value of the process parameter. In another implementation, the metadata of the data packet may contain the memory address from where the process parameter value is read and the type and size of the process parameter but not the technical identifier for the process parameter. When large number of such data packets are transmitted continuously in the OT network, identifying the type of process parameter becomes a cumbersome task for the security teams who are monitoring the network as they may be technical variable names. The operators of the industrial process and security teams may not be familiar with the addresses of the process parameters or the process parameter names as they pass through the network. On the receiving end of the traffic-in the SCADA system or HMI the users typically have human readable names assigned to these variables.

Therefore, the tag creation module 302e is configured to create a tag name for the process parameter in a standard nomenclature by mapping the metadata of each data packet to a corresponding user-given name or human readable name for the process parameter. In a non-limiting example, if technical identifiers for process parameters are T1_level, PV_1, Temp_1 for tank level, pressure, and temperature respectively, the tag creation module 302e may be configured to create a tag name that is user friendly and descriptive such as Tank-level, Pressure Sensor, Temperature_Setpoint. In a non-limiting example, the standard nomenclature is created by mapping the metadata of each data packet to a corresponding user-defined tag name using XML schema.

In an embodiment, the standard nomenclature created by the tag creation module is saved in a configuration file. The configuration file may be ingested into the engineering software of manufacturers of field devices before implementation. The mapping schema may be customized depending upon the communication protocol used by the manufacturers of the field devices. In an embodiment, the data comprising the process parameter and its associated process parameter value, and the user-defined tag name for each data packet in stored in historian for data analytics.

Thus, the system 300 employs reverse engineering to understand the process parameter values, discern between the values and attribute them to the process parameters, and also to decipher the type of process variable or process parameter (e.g. speed/temp/pressure, etc.) by giving a standard naming format. The approach gives the security teams the unique ability to identify process parameters in the monitored traffic without the assistance of the operational teams (operators/engineers). Assigning user-given names to process parameters allows bridging the communication gaps between the security teams and the operators of the industrial process, as they provide the context about the variable's functionality. The security teams can therefore ensure protection of process parameters from cyber security threats and ensure compliance with security protocols.

The system 300 further comprises a presentation module 302f coupled to the tag creation module 302e. The presentation module 302f is configured to present data comprising the process parameter and its associated process parameter value, and the user defined tag name for each data packet to a user. This enables the security teams monitoring the network traffic to get insights on the process parameters and its associated process parameter values along with its corresponding tag names in standard nomenclature. As the tag names created by the tag creation module are user-defined, the values can be quickly deciphered to understand what the process parameter represents as to temperature, pressure, speed, flow rate, etc. of the assets. This standard nomenclature also enables quick detection of any cybersecurity risk.

The system 300 further comprises an operations module 302g coupled to the presentation module 302f. The operations module 302g may enable the performance of one or more operations on the data presented by the presentation module 302g. In one example implementation, the one or more operations on the data may be performed by the security teams to scrutinize the data and detect vulnerabilities gaining better cyber insights. In another example operation, the users may analyze the data for business intelligence purposes.

In one or more embodiments, the system 300 may include one or more software modules or components for naming process parameters in ICS networks in accordance with the one or more embodiments of the present disclosure. In an embodiment, the one or more software modules may include but not limited to monitoring module 302c, parsing module 302d, tag creation module 302e, presentation module 302f and operations module 302g which implements the functions of the system 300 through a processor 302a.

In an embodiment, a memory 302b may store and execute instructions for implementing the functions of the system 300. The memory 302b may be non-transitory and may include, for example, one or more volatile and/or non-volatile memories. In some embodiments, the memory 302b includes or embodies an electronic storage device (e.g., a computer readable storage medium). In some embodiments, the memory 302b is configured to store information, data, content, applications, instructions, or the like, for enabling a system to carry out various operations and/or functions in accordance with example embodiments of the present disclosure.

In an embodiment, one or more modules of the system 300 may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.).

Although components are described with respect to functional limitations, it should be understood that the particular implementations necessarily include the use of particular computing hardware. It should also be understood that in some embodiments certain of the components described herein include similar or common hardware.

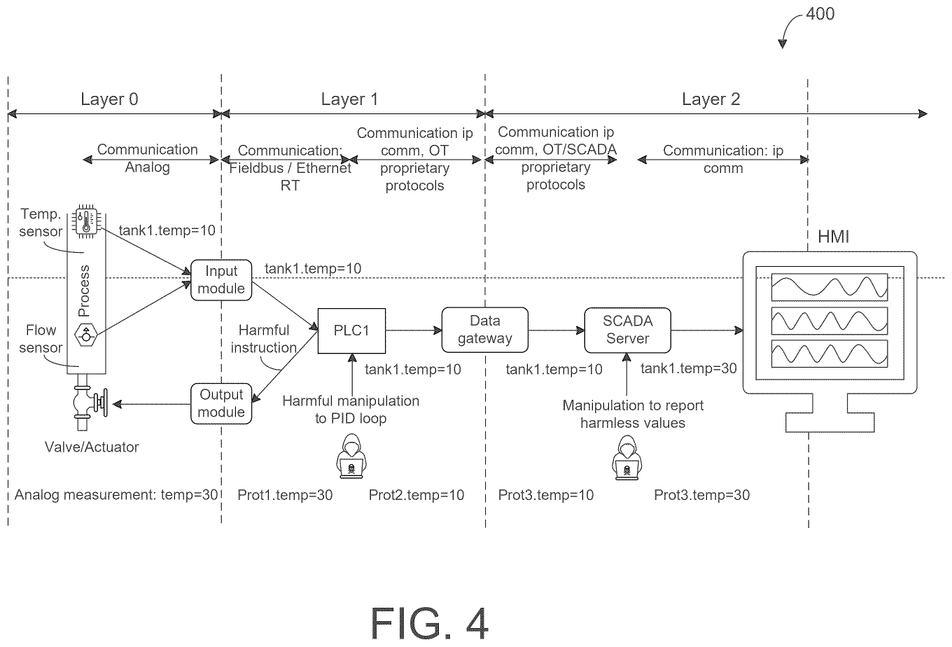

FIG. 4 illustrates an exemplary scenario of data flow in a process control environment with network intrusion. As shown in FIG. 4, the data flow of a typical industrial process consists of the PLCs obtaining input measurement values describing the physical process. The input measurement values such as the process parameter values are obtained typically from field devices such as sensors located at network level 0 (network layer 0). An example of process parameter value as indicated in FIG. 4 is temperature reading of tank 1 (tank1.temp=30). According to predefined logic, the PLCs situated at network level 1 (layer 1) issue commands to field devices that change the process. The commands from PLCs are issued to devices such as actuators/motors/valves etc. in layer 0. This is typically referred to as a Proportional-Integral-Derivative (PID) loop. Thereafter, the PLCs report the process parameter values describing the state of the process to operator level systems such as the HMI/SCADA at layer 2.

In case of a security breach or vulnerability, as illustrated in FIG. 4, the code on the PLC is manipulated by an adversary to offset the process resulting in a change in temperature reading (tank1.temp=10) at layer 1, thereby resulting in sending harmful instructions to the field devices in layer 0. In this scenario, the PLCs transmit the manipulated process parameter values (tank1.temp=10) to HMI/SCADA at layer 2. However, the adversary again masks the reporting of the process parameter value and reports (tank1.temp=30) to SCADA server indicating “healthy behavior” data.

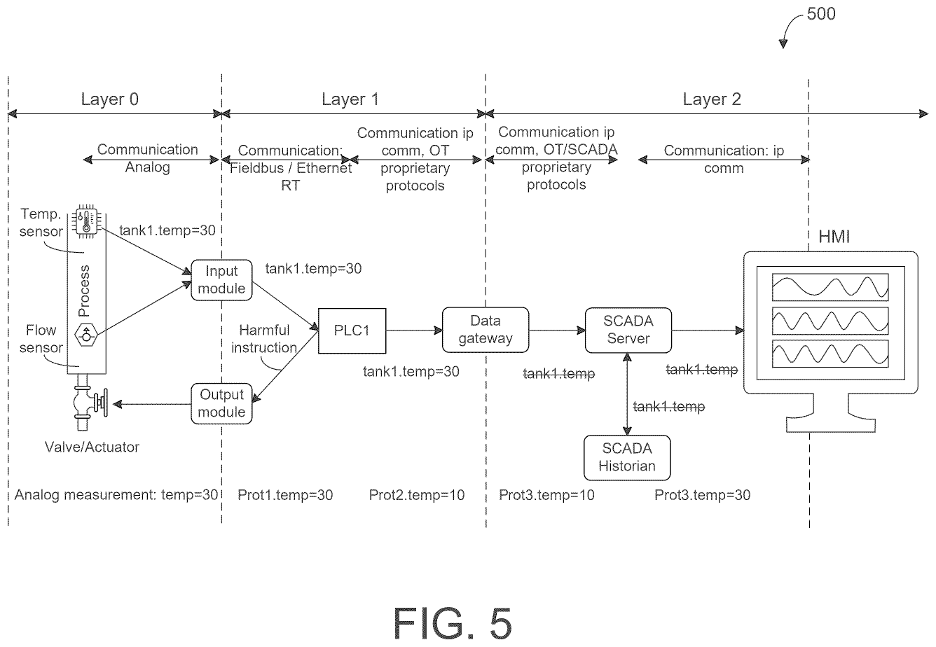

FIG. 5 illustrates another exemplary scenario of data flow in a process control environment with network intrusion. As can be seen in FIG. 5, the data flow of the industrial process consists of the PLCs obtaining input measurement values describing the physical process. The input measurement values such as the process parameter values are obtained from field devices such as sensors located at network level 0 (network layer 0). An example of process parameter value as indicated in FIG. 5 is temperature reading of tank 1 (tank1.temp=30). According to predefined logic, the PLCs situated at network level 1 (layer 1) issue commands to field devices that change the process. The commands from PLCs are issued to devices such as actuators/motors/valves etc. in layer 0. Thereafter, the PLCs report the process parameter values describing the state of the process to operator level systems such as the HMI/SCADA at layer 2. The correct temperature reading of tank 1 (tank1.temp=30) has been reported from the PLC at layer 1 to the SCADA server at layer 2. However, as a result of human or configuration error, the data stopped flowing thereafter, but static values are displayed on HMI without notification, as illustrated in FIG. 5.

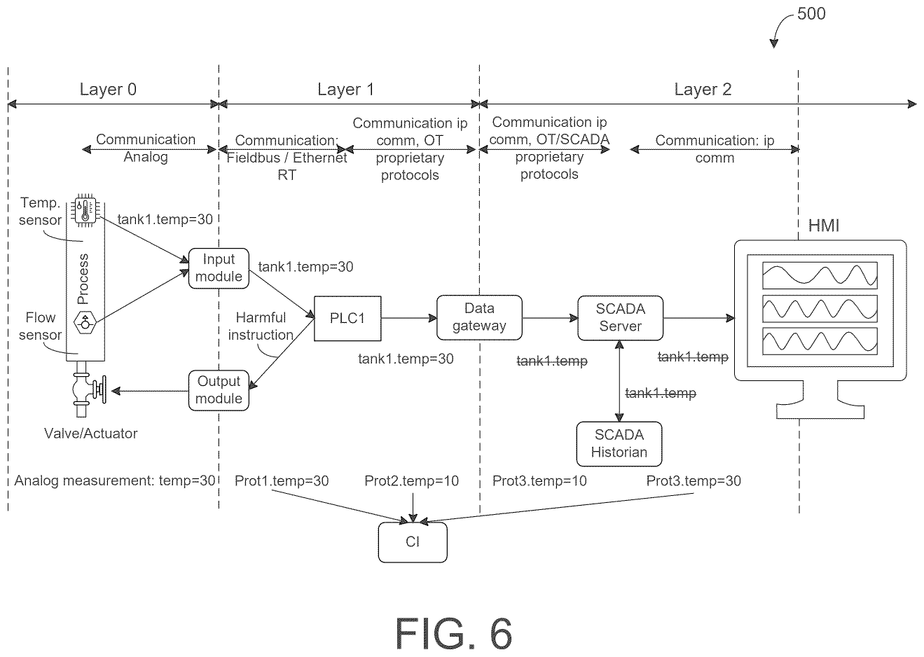

FIG. 6 is an exemplary illustration of a data flow of a process control environment monitored by the system (of FIG. 3) in accordance with one or more embodiments described herein.

As is seen in FIG. 6, the cyber insights (CI) system or the intrusion detection system is configured to passively monitor the data traffic in the process control environment. The CI system is configured to monitor the process variables embodied in data packets across different network layers and ensure that the data that is transmitted is without security breach as illustrated in FIG. 6. The exemplary scenarios of network intrusion shown in FIGS. 4 and 5 can be eliminated or reduced when monitored by the CI system as shown in FIG. 6. The CI systems enable giving a standard nomenclature to the process parameters transmitted through the network thereby helping the security teams with quick detection and elimination of security breaches.

Similar to FIGS. 4 and 5 discussed above, the data flow of the process consists of the PLCs obtaining input measurement values describing the physical process. The input measurement values such as the process parameter values are obtained typically from field devices such as sensors located at network level 0 (network layer 0). An example of process parameter value as indicated in FIG. 6 is temperature reading of tank 1 (tank1.temp=30). According to predefined logic, the PLCs situated at network level 1 (layer 1) issue commands to field devices that change the process. The commands from PLCs are issued to devices such as actuators/motors/valves etc. in layer 0. This is typically referred to as a Proportional-Integral-Derivative (PID) loop. Thereafter, the PLCs report the process parameter values describing the state of the process to operator level systems such as the HMI/SCADA at layer 2. The protocols used for communication may differ between physical components, and the sampling rate may differ per segment but in essence a process parameter value describing a characteristic of the process will travel up cross all the layers of the OT/IT network (L0-sensor, L1-PLC, L2-SCADA, and higher to historians/PI servers). The temperature reading of tank 1 (tank1.temp=30) obtained from sensors is transmitted from the PLC at layer 1 to the SCADA server at layer 2. Further, the temperature reading (tank1.temp=30) is further reported to the SCADA server for monitoring and control by the HMI.

In certain instances, the operators of the CI system may have an option to override some actions in the process or stop them altogether. The data is used for business intelligence purposes on enterprise level, to improve and make the system more secure and efficient. The data thus obtained is used to provide higher level view of single processes and a wider picture overlooking several processes together or a whole plant.

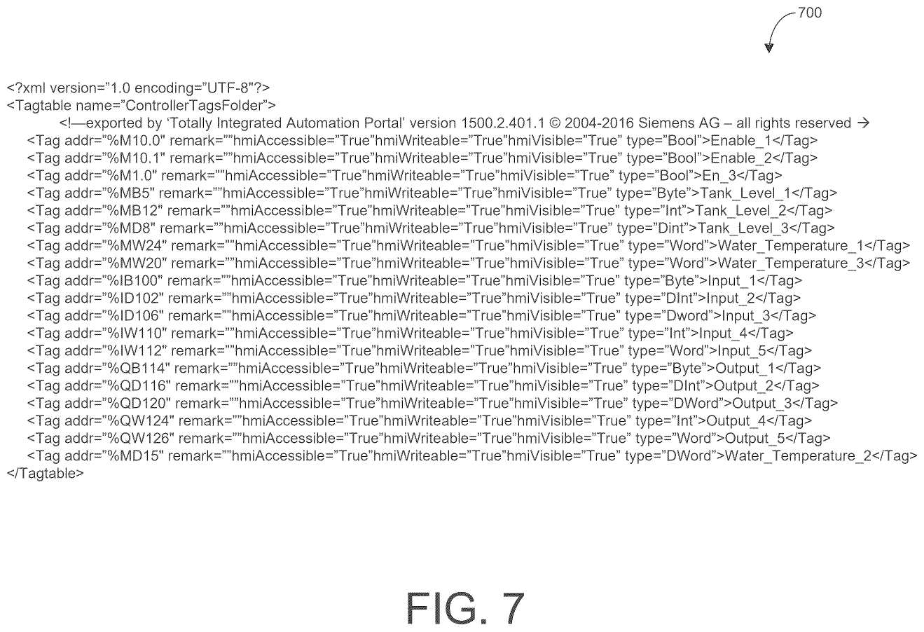

FIG. 7 is an exemplary mapping schema implemented by the system of FIG. 3 for naming process parameters in accordance with the one or more embodiments described herein. In an exemplary embodiment, the mapping schema of FIG. 7 indicates the mapping of metadata of data packet transmitted through the OT network to a corresponding user-defined tag name for the process parameter. In one implementation, the metadata of a data packet may contain a technical variable identifier and the payload. In another implementation, the metadata of the data packets may contain the memory address from where the process parameter value can be fetched and the type and size of the process parameter. The metadata of the data packet may thus vary based on the communication protocol used across network levels. Some non-limiting examples of proprietary communication protocols may include CIP industrial protocol and S7 protocol.

In the exemplary mapping schema of FIG. 7, the user-defined tag names may be indicated as enable_1, enable_2, Tank_Level_1, Tank_level_2, water_temperature_1, water_temperature_3, etc. In one example, the memory addresses M10.0 is mapped to the user-defined name, Enable_1. In another example, the memory address MW20 is mapped to user-defined tag name, water_temperature_3. In an embodiment, the mapping schema is stored in XML format or in a pre-defined format and is saved in a configuration file. The configuration file may be ingested into the engineering software of manufacturers of the process control devices. The mapping schema may also be customized depending upon the communication protocol used by the manufacturers of the field devices. With the mapping feature ingested into the engineering software, the users of the CI system 300 may obtain better visibility on the process parameters as both technical variable names and the user-defined tag names with values are displayed to the user for data analytics.

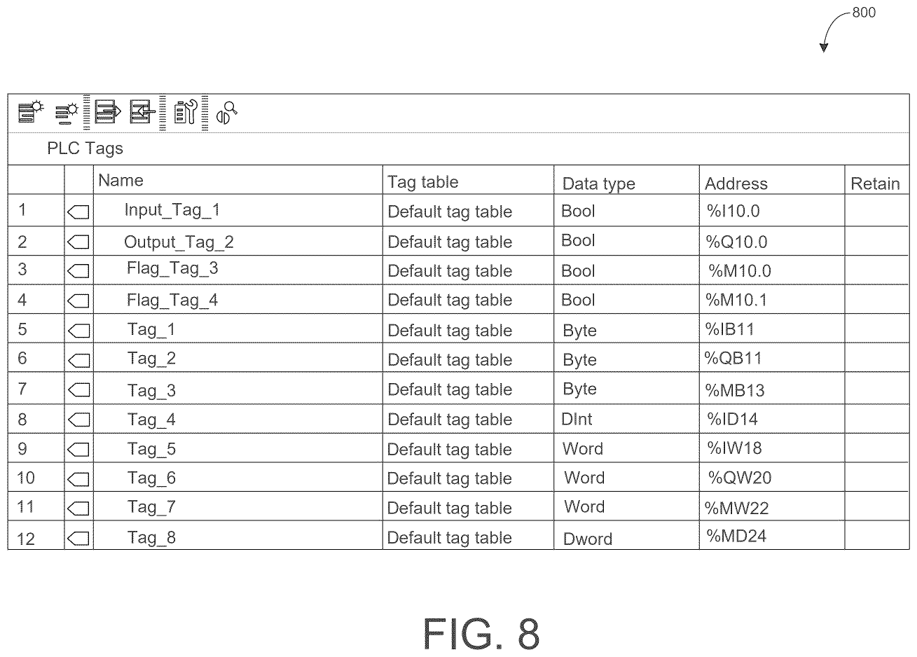

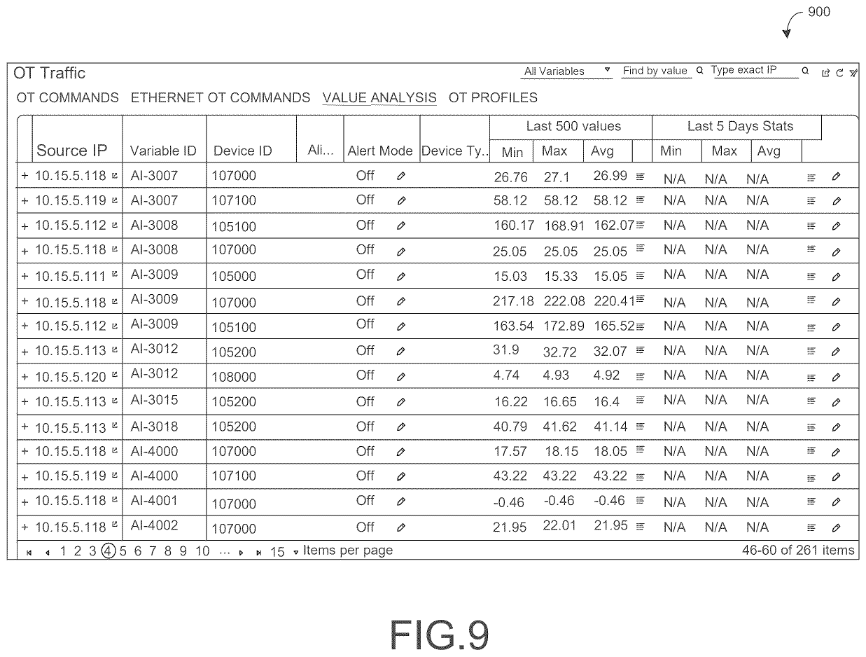

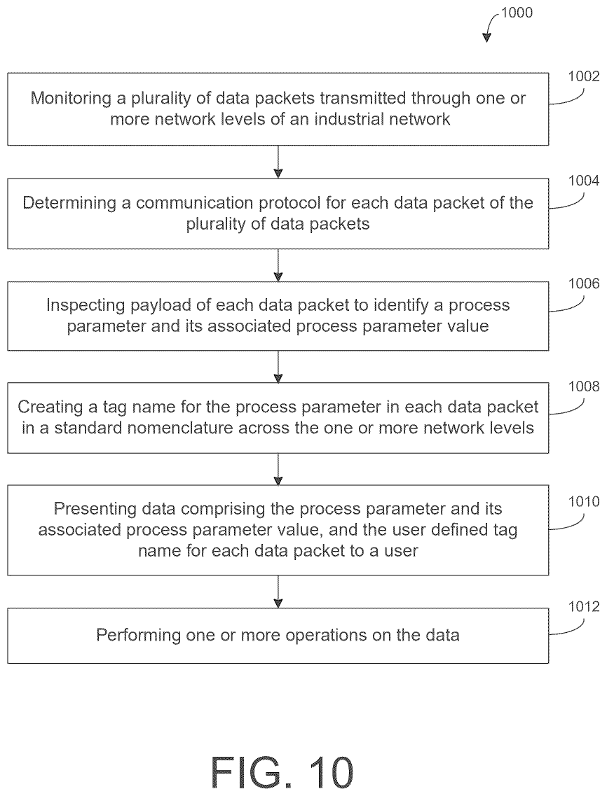

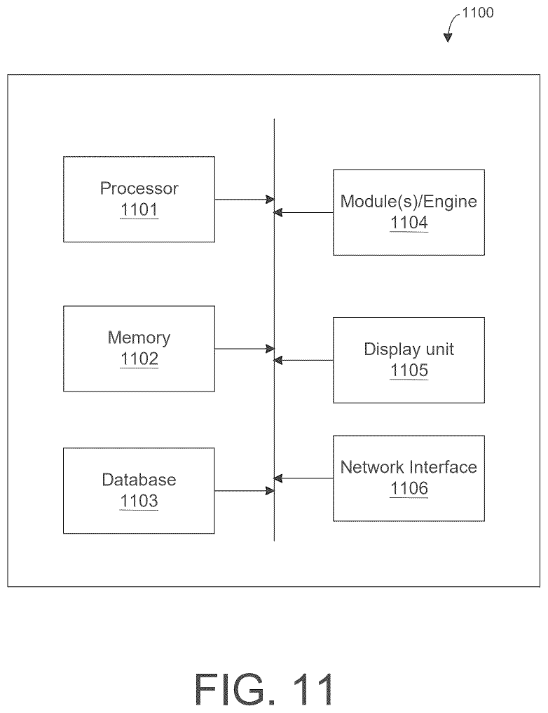

FIG. 8 is an exemplary table indicating the creation of tag names by the system of FIG. 3 in accordance with the one or more embodiments described herein. In an embodiment, the table depicted in FIG. 8 shows some example tag names. Some examples of tag names may be input_tag_1, output_tag_1, flag_tag_1, flag_tag_2, etc. For example, in a proprietary communication protocol, the memory address from where the values of the process parameters are read may be specified by the memory area such as DB, M, I, Q, MB, etc. In the exemplary table of FIG. 8, Q10.0, M10.0, MB13, etc. are the memory addresses from where the process parameter values are read. The value of the process parameter may be a a bit, an integer, a floating-point number or any data type defined in the PLC. The process parameter values may be read from or written into the memory address. The table also shows the size of the process parameters which depends on its data type. The data types of the process parameters may be bit, byte, bool, word, Dword, etc.

In an embodiment, the exemplary mapping schema illustrated in FIG. 7 may be customised and the PLCs programmed according to the pre-defined format of the engineering software of the equipment manufacturers. The tag names can be created and customised to suit the operational context and requirements of the enterprise.

FIG. 9 is an exemplary table showing insights on the OT traffic monitored by the system of FIG. 3 in accordance with the one or more embodiments described herein. In an exemplary embodiment, the table depicted in FIG. 9 shows the data captured in the OT traffic when monitored by the system of FIG. 3. The data shows process variable identifiers, device identifiers and the process parameter values obtained from the physical components in the OT network. The statistics of the different process parameter values obtained over a period of time for one or more physical components are also stored in historian for analytics and BI purposes. In a non-limiting example, the last 500 process parameter values for various process parameters like temperature, pressure, level, flow rate, etc. (variable ID) for a particular asset (device ID) of the OT system are captured and stored in historian for a particular period of time. The analysis on the behaviour of the data is performed by recording the maximum, minimum and average values of process parameters obtained over a period of time. As the CI system, 300 is configured to render standard human readable names for identifying the process parameters, analysis on the data becomes less cumbersome as the security teams may not require help from the operations teams to understand their function. The human readable names are descriptive and easier to understand the purpose of the process parameter, enabling quick detection and resolution of malicious attacks in the event of any deviation in the operational condition of the asset.

FIG. 10 illustrates an exemplary flow diagram of a method for naming process parameters in industrial networks in accordance with one or more embodiments described herein. In an embodiment, the method, 1000 may be implemented by the system as described above in FIG. 3. The method 1000 is illustrated as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations can be combined in any order and/or in parallel to implement the method.

According to an embodiment, the method 1000 may be implemented by one or more processors or modules illustrated and explained through FIGS. 3,11 therefore detailed explanation of the same is omitted here for the sake of brevity.

The method begins at step 1002, wherein the method 1000 includes monitoring a plurality of data packets transmitted through one or more network levels of an industrial network. The plurality of data packets are transmitted across network levels, the data packets comprising data that contain measured parameters indicative of the operational condition or working condition of the physical assets. The measured process parameters indicate the physical state or behavior of the system, and the value of the process parameter is the current state or data of the process parameters. The measured process parameter values may be transmitted from one network level to another network level using proprietary communication protocols. The method includes passively monitoring the network by inspecting a mirror of all the traffic sent to it by switches of the network.

At step 1004, the method 1000 includes determining a communication protocol for each data packet of the plurality of data packets, wherein the communication protocol for each data packet varies based on the one or more network levels. In an embodiment, the method comprises utilizing Deep Packet Inspection (DPI) capabilities to understand various proprietary communication protocols used by manufacturers of industrial assets and SCADA systems. The communication protocol is identified based on the metadata of the data packets transmitted across the network levels. The metadata of the data packet may include for source address, destination address, identifier of the communication protocol, payload, error correction code, etc.

At step 1006, the method 1000 includes inspecting payload of each data packet to identify a process parameter and its associated process parameter value, wherein the process parameter value is generated by a process control device. In an example embodiment, process control devices such as the temperature sensors, pressure sensors, level and flow rate sensors, etc. may measure values of the process parameters which represent the current state of the process parameters. In an embodiment, the method comprises utilizing the DPI technology to parse the payload content based on the determined communication protocol. The method comprises detecting commands used for exchange of process parameters, discerning between the values of process parameters and attributing them to process parameters.

At step 1008, the method 1000 includes creating a tag name for the process parameter in each data packet in a standard nomenclature across the one or more network levels, wherein the standard nomenclature is created by mapping metadata of each data packet to a corresponding user-defined tag name for the process parameter. Typically, the metadata of a data packet may include identifiers or tags for process parameters or memory address from where the process parameter values are fetched, etc. The metadata for each data packet may vary based on the communication protocol being used across various network levels. In a non-limiting example, the standard nomenclature is created by mapping the metadata of each data packet to a corresponding user-defined tag name using XML schema. The method comprises saving the standard nomenclature in a configuration file. The method further comprises storing the data comprising the process parameter and its associated process parameter value, and the user-defined tag name for each data packet.

At step 1010, the method 1000 comprises presenting data comprising the process parameter and its associated process parameter value, and the user defined tag name for each data packet to a user. This enables the security teams monitoring the network traffic to get insights on the process parameters and its associated process parameter values along with its corresponding tag names in standard nomenclature. As the tag names created by the tag creation module are user-defined, the values can be quickly deciphered to understand what the process parameter represents as to temperature, pressure, speed, flow rate, etc. of the assets. This standard nomenclature also enables quick detection of any cybersecurity risk.

At step 1012, the method 1000 comprises performing one or more operations on the data. In one example implementation, the one or more operations on the data may be performed by the security teams to scrutinize the data and detect vulnerabilities gaining better cyber insights. In another example operation, the users may analyze the data for business intelligence purposes.

FIG. 11 illustrates a general block diagram of an exemplary computing system 1100 used in the intrusion detection system (IDS) or CI system 300, according to an embodiment of the present disclosure.

In an example, the computing system 1100 includes a processor 1101 which may be a single processing unit or a number of units, all of which could include multiple computing units. The processor 1101 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 1101 is configured to fetch and execute computer-readable instructions and data stored in a memory 1102.

The memory 1102 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the computing system 1100 may include one or more software module(s) or component(s) or engine(s) 1104 capable of performing a stated task or function in accordance with the one or more embodiments of the present disclosure. As used herein, the module(s) or component(s) or engine(s) 1104 may be implemented on a hardware component such as a server independently of other modules, or a module can exist with other modules on the same server, or within the same program. The one or more module(s) or component(s) or engine(s) 1104 may include a program, a subroutine, a portion of a program, a software component or a hardware component capable of performing a stated task or function. The module(s) 1104 may be implemented on a hardware component such as processor one or more microprocessors, microcomputers, microcontrollers, digital signal processors, central processing units, state machines, logic circuitries, and/or any devices that manipulate signals based on operational instructions. The module(s) or component(s) or engine(s) 1104 when executed by the processor 1101 may be configured to perform any of the described functionalities. In an alternate embodiment, the functions of the aforesaid modules may be performed by the processor(s) 1101.

The computing system 1100 may comprise a database 1103 and may be implemented with integrated hardware and software. The hardware may include a hardware disk controller with programmable search capabilities or a software system running on general-purpose hardware. Examples of databases are but not limited to, in-memory databases, cloud databases, distributed databases, embedded databases, and the like. The database amongst other things, serves as a repository for storing data processed, received, and generated by one or more of the processors 1101, and the module(s) or component(s) or engine(s) 1104.

In an embodiment, the module(s) or component(s) or engine(s) 1104 may be implemented with an AI/ML module. The module(s) or component(s) or engine(s) may be implemented with an AI module that may include a plurality of neural network layers. Examples of neural networks include, but are not limited to, a convolutional neural network (CNN), a deep neural network (DNN), a recurrent neural network (RNN). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

The computing system 1100 comprises a display unit 1105 that includes a computer monitor, a touch screen, an output device capable of displaying the graphics, and the like. The display unit 1105 is configured to display visual output in desktops, laptops, and workstations. The display unit 1105 may come in different sizes, resolutions, and types (such as LCD, LED, or OLED).

The computing system 1100 comprises a network interface 1106 configured to provide and establish communication with any electronic device via a public network, private network, or any wireless communication technology.

Embodiments of the present disclosure may thus provide an efficient system and method for quickly detecting and mitigating network intrusion in ICS networks. The system is aimed to provide optimum performance by detecting operational deviations or other anomalous activity, making it easy for the security teams to effectively resolve security issues and problem scenarios. The disclosed techniques aids in improving the overall health of the system by reducing costs, optimizing resources, reducing time spent on manual processes, thereby better visibility on cyber security posture.

The disclosed system and method may also leverage Artificial intelligence (AI) algorithms to implement the various functionalities disclosed herein. The AI algorithms may be utilized to monitor data transmitted through the network in real-time and provide a standard naming format for the process variables such that better cyber insights on the ICS networks is obtained.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1. A method comprising:
monitoring a plurality of data packets transmitted through one or more network levels of an industrial network;
determining a communication protocol for each data packet of the plurality of data packets, wherein the communication protocol for each data packet varies based on the one or more network levels;
inspecting payload of each data packet to identify a process parameter and its associated process parameter value, wherein the process parameter value is generated by a process control device;
creating a tag name for the process parameter in each data packet in a standard nomenclature across the one or more network levels, wherein the standard nomenclature is created by mapping metadata of each data packet to a corresponding user-defined tag name for the process parameter;
presenting data comprising the process parameter and its associated process parameter value, and the user defined tag name for each data packet to a user; and
performing one or more operations on the data.

2. The method of claim 1, wherein the metadata for each data packet varies based on the communication protocol.

3. The method of claim 1, wherein the metadata comprises memory address from where the process parameter value is fetched.

4. The method of claim 1, wherein the metadata further comprises an identifier for the process parameter.

5. The method of claim 1, further comprising saving the standard nomenclature in a configuration file.

6. The method of claim 1, further comprising storing the data comprising the process parameter and its associated process parameter value, and the user-defined tag name for each data packet.

7. The method of claim 1, wherein the process control device controls an industrial process.

8. The method of claim 1, wherein the process parameter comprises a characteristic of the industrial process controlled by the process control device.

9. The method of claim 1, wherein the data presented to the user is utilized for detecting security threats within the industrial network.

10. The method of claim 1, wherein the data presented to the user is utilized for business intelligence.

11. A system comprising:
a processor; and
a memory storing program instructions which, when executed by the processor, causes the processor to:
monitor a plurality of data packets transmitted through one or more network levels of an industrial network;
determine a communication protocol for each data packet of the plurality of data packets, wherein the communication protocol for each data packet varies based on the one or more network levels;
inspect payload of each data packet to identify a process parameter and its associated process parameter value, wherein the process parameter value is generated by a process control device;
create a tag name for the process parameter in each data packet in a standard nomenclature across the one or more network levels, wherein the standard nomenclature is created by mapping metadata of each data packet to a corresponding user-defined tag name for the process parameter;
present data comprising the process parameter and its associated process parameter value, and the user defined tag name for each data packet to a user; and
perform one or more operations on the data.

12. The system of claim 11, wherein the metadata for each data packet varies based on the communication protocol.

13. The system of claim 11, wherein the metadata comprises memory address from where the process parameter value is fetched.

14. The system of claim 11, wherein the metadata further comprises an identifier for the process parameter.

15. The system of claim 11, wherein the processor is configured to save the standard nomenclature in a configuration file.

16. The system of claim 11, wherein the processor is configured to store the data comprising the process parameter and its associated process parameter value, and the user-defined tag name for each data packet.

17. The system of claim 11, wherein the process control device controls an industrial process.

18. The system of claim 11, wherein the process parameter comprises a characteristic of the industrial process controlled by the process control device.

19. The system of claim 11, wherein the data presented to the user is utilized for detecting security threats within the industrial network.

20. A non-transitory computer-readable storage medium, storing program instructions, the program instructions, when executed, perform the steps of:
monitoring a plurality of data packets transmitted through one or more network levels of an industrial network;
determining a communication protocol for each data packet of the plurality of data packets, wherein the communication protocol for each data packet varies based on the one or more network levels;
inspecting payload of each data packet to identify a process parameter and its associated process parameter value, wherein the process parameter value is generated by a process control device;
creating a tag name for the process parameter in each data packet in a standard nomenclature across the one or more network levels, wherein the standard nomenclature is created by mapping metadata of each data packet to a corresponding user-defined tag name for the process parameter;
presenting data comprising the process parameter and its associated process parameter value, and the user defined tag name for each data packet to a user; and
performing one or more operations on the data.
